(19) United States
(12) Patent Application Publication
(10) Pub. No.: US 2018/0012450 A1
(43) Pub. Date: Jan. 11, 2018

(54) CASINO WAGERING SYSTEM

(71) Applicant: Chi Fat Au-Yeung, Birmingham (GB)

(72) Inventor: Chi Fat Au-Yeung, Birmingham (GB)

(21) Appl. No.: 15/465,369

(22) Filed: Mar. 21, 2017

(30) Foreign Application Priority Data
May 14, 2016 (GB) 1608500.3

(51) Int. Cl. G07F 17/32; A63F 1/00; A63F 1/12; A63F 1/06; A63F 1/10

(52) U.S. Cl. CPC G07F 17/3244; A63F 1/067; A63F 1/10; A63F 1/12; G07F 17/323; G07F 17/3293; A63F 1/00; G07F 17/3288; G07F 17/3239; A63F 2001/001; G07F 17/3209; G07F 17/3218; G07F 17/3211

(57) ABSTRACT

A method, system, and computer readable storage to implement a baccarat side wager which is placed alongside the main bet. The baccarat game is dealt according to standard baccarat rules. In order to win the side wager, all of the player's cards have to be a single color, and all of the dealer's (banker's) cards have to be the opposite color. If this condition is not true, then the side wager loses.

### CROSS REFERENCE TO RELATED APPLICATIONS

This application claims foreign priority under 35 U.S.C. §119 to application GB1608500.3, filed on May 14, 2016, by inventor Chi Fat Au-Yeung, which is incorporated by reference herein in its entirety.

### BACKGROUND OF THE INVENTION

### Field of the Invention

The present general inventive concept is directed to a method, apparatus, and computer readable storage medium directed to a wagering game.

### Description of the Related Art

Casino games (both played in live format and electronic format) are a billion dollar industry. The industry is also striving to produce new and exciting wagering methods which players may find fresh and exciting and the house (casino) finds profitable.

### SUMMARY OF THE INVENTION

It is an aspect of the present invention to provide an exciting casino system.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 is a flowchart illustrating an exemplary method of implementing a baccarat side wager, according to an embodiment;

FIG. 2 is a drawing of a gaming table and layout according to an embodiment;

FIG. 3A is a drawing illustrating a gaming table, according to an embodiment;

FIG. 3B is a block diagram illustrating an electronic player tracking system associated with each gaming table, according to an embodiment;

FIG. 4A is a block diagram illustrating exemplary hardware that can be used to implement an electronic version of the methods described herein; and

FIG. 4B is a block diagram illustrating an exemplary network configuration to implement a player playing an online version of the methods described herein;

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

The game of baccarat is described in U.S. Pat. No. 6,299,171 and U.S. publication 2008/0032760, both of which are incorporated by reference herein in their entireties. The game can be played with any number (e.g., 1-8) of standard 52 card decks.

The known game of baccarat is played as follows. The player chooses a bet (a main bet or main wage) to place (player, banker, or tie). The cards are dealt face down, two cards to the player and two cards to the banker, all face up. Depending on the two initial hands, both the player and the banker may draw a third card or stand. The hand with the higher total wins. Note that “dealer” and “banker” are synonymous, thus “dealer's hand” is the same as “banker's hand” and a bet on the “dealer” is the same as a bet on the “banker.”

The cards Ace to Nine are worth 1 to 9 points according to their respective pip-counts. Ten, Jack, Queen and King are each worth zero points. The point total of a hand is the last digit of the sum of the cards. Examples of Baccarat point counts are as follows: Ace(1)+5=6=Hand total=6; 10 (0)+3+6=19=Hand total=9; 9+5=14=Hand total=4.

If the player or the banker (or both) achieve a total of 8 or 9 on the initial deal (known as a ‘natural’), no further cards are drawn and the game is evaluated based on both initial two card hands. If neither player has a natural, then the play proceeds as follows. If the player has an initial total of 0-5, the player draws a third card. If the player then has an initial total of 6 or 7, the player stands.

If the player stands, the banker uses only the banker's own hand and acts according to the same rule as the player (the banker draws a third card if the banker has 0-5 and stands if the banker has 6 or 7).

If the player drew a third card, then the banker acts according to Table I

TABLE I
Player Draw Card Banker Action

| | |
|---|---|
| 2-3 | banker draws if banker has 0-4, stands if banker has 5-7 |
| 4-5 | banker draws if banker has 0-5, stands if banker has 6-7 |
| 6-7 | banker draws if banker has 0-6, stands if banker has 3-7 |
| 8 | banker draws if banker has 0-2 and stands if banker has 3-7 |
| A, 9, 10 or face card | banker draws if banker has 0-3 and stands if banker has 4-7 |

The player (player or banker) with the highest hand wins. The score of each hand is computed by taking the physical point total of each hand modulo 10, which means that after adding the value of the cards the tens digit is ignored. For example, a hand of 3 and 4 is 7. A hand of 8 and 6 is scored as 4 (14 modulo 10). The first digit is dropped because the total is higher than 9. A hand consisting of 4 and 6 is worth zero. The highest (best) score that can be achieved is 9 (formed using 4/5; face card/9; A/8, 7/2, etc.)

If the banker has the higher hand then the banker bet wins and if the player has the higher hand then the banker bet loses. If the player has the higher hand then the player bet wins and if the banker has the higher hand then the player bet loses. On event of a tie, the player and banker bets will push (neither win nor lose). The player can also bet on a tie. If the player's point total equals the banker's point total then the tie bet wins, otherwise the tie bet loses.

Table I below represents an exemplary set of rules regarding a contrast side wager.

TABLE I
1) Contrast Bonus Baccarat is a side wager suitable for play at any baccarat game
dealt from an eight deck shoe.
2) The Contrast Bonus Baccarat Wager is placed at the start of the hand, along with
the regular baccarat wagers.
3) Once all wagers are placed, play proceeds as normal.
4) The Contrast Bonus Baccarat Wager is resolved at the end of the round, and will
be eligible for a payout if one of the following two conditions are true:
5) If all player cards used are red, and all banker cards are black.
6) If all player cards used are black, and all banker cards are red.
7) If either of these conditions are met, the Contrast Bonus Baccarat Wager is paid
depending on whether a total of four, five or six cards were used. The payout varies
depending on the paytable used, as follows:

| Event | Paytable 1 | Paytable 2 | Paytable 3 | Paytable 4 | Paytable 5 |
|---|---|---|---|---|---|
| Contrast, total 4 cards. | 5:1 | 5:1 | 5:1 | 6:1 | 5:1 |
| Contrast, total 5 cards. | 15:1 | 15:1 | 17:1 | 15:1 | 15:1 |
| Contrast, total 6 cards | 35:1 | 33:1 | 30:1 | 30:1 | 30:1 |
| Calculated House Edge | 4.96% | 6.96% | 6.15% | 5.20% | 9.96% |

8) Otherwise, the Contrast Bonus Baccarat Wager loses, and is collected.
9) All cards are collected, and a new round may begin.

Thus, as can be seen from Table I, the side wager wins when all of the player's cards are all the same color and all of the dealer's cards are all of the opposite color to the player's cards.

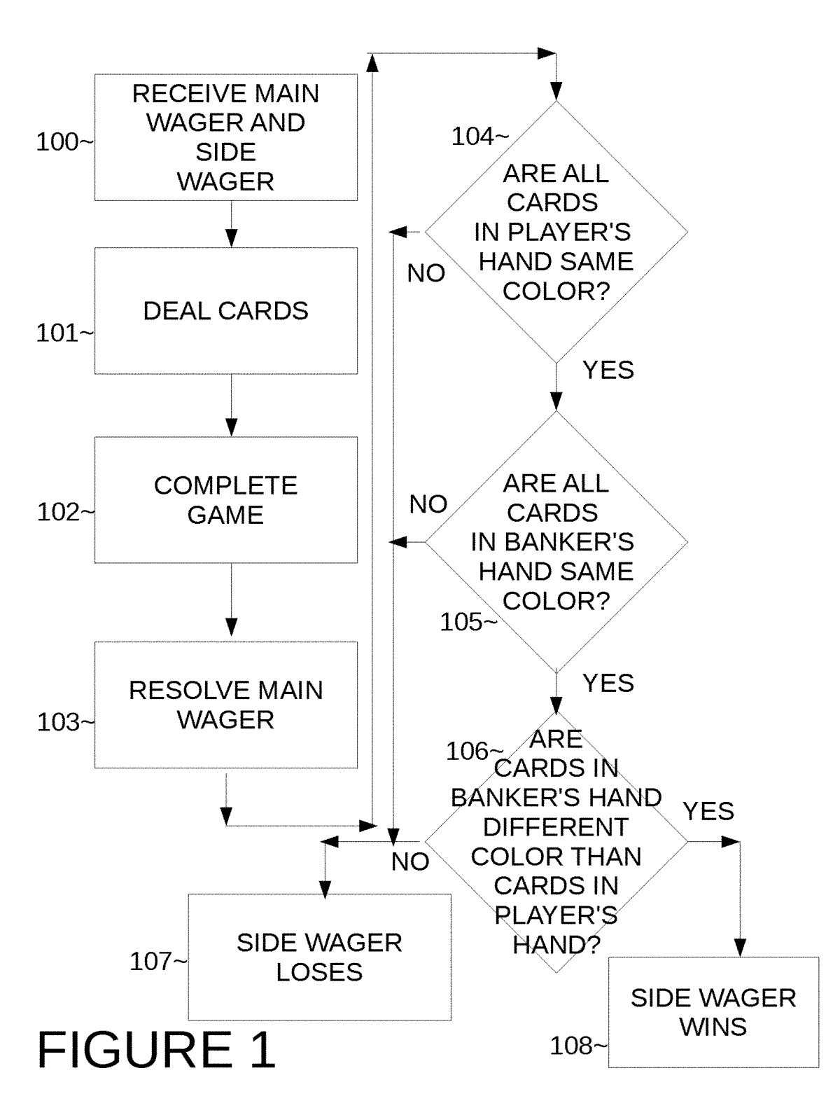

FIG. 1 is flowchart illustrating an exemplary method of implementing a baccarat game side wager, according to an embodiment.

The method can begin with operation 100, which receives the main wager and an optional side wager from the player. This can be done as known in the art.

From operation 100, the method proceeds to operation 101, which deals cards to the player and to the banker (also referred to as dealer).

From operation 101, the method proceeds to operation 102, which completes the game. This includes dealing any additional cards to the player and/or the banker as needed. This can be done as known in the art.

From operation 102, the method proceeds to operation 103, which resolves the main wager. This can be done as known in the art.

From operation 103, the method proceeds to operation 104, which determines whether all of the cards in the player's hand are of the same color (e.g., either all red or all black). If all of the cards in the player's hand are not all the same color, then the method proceeds to operation 107, in which the side wager loses (is taken from the player).

If in operation 104, all of the cards in the player's hand are of the same color, then the method proceeds to operation 105, which determines whether all of the cards in the banker's hand are of the same color. If all of the cards in the banker's hand are not all of the same color, then the method proceeds to operation 107.

If in operation 105, all of the cards in the banker's hand are all of the same color (e.g., they are all red or all black), then the method proceeds to operation 106, which determines whether the cards in the banker's hand a different color than the cards in the player's hand. If the cards in the banker's hand are the same color as the cards in the player's (e.g., all of the cards in both hands are red or all of the cards in both hands are black), then the method proceeds to operation 107.

If in operation 106, it is determined that all of the cards in the banker's hand are of a different color than all of the cards in the player's hand (e.g., the cards in the banker's hand are all red and the cards in the player's hand are all black, or the cards in the banker's hand are all black and the cards in the player's hand are all red), then the method proceeds to operation 108.

In operation 108, the side wager wins and is paid a payout. The payout can be determined using a paytable, such as that shown in Table I, item 7. In an embodiment, the more cards that are utilized (e.g., adding the number of the cards in the player's hand with the number of cards in the banker's hand) then the higher the payout would be. The payout is based on an amount of the side wager. For example, if the player bets $1 on the side wager, and the banker has two black cards and the player has two red cards, then the payout would be (using paytable 1) 5:1 or $5 (since there are a total of four cards being utilized). If in the same example, the banker had three black cards, then the payout would be 15:1 or $15 (using payable 1).

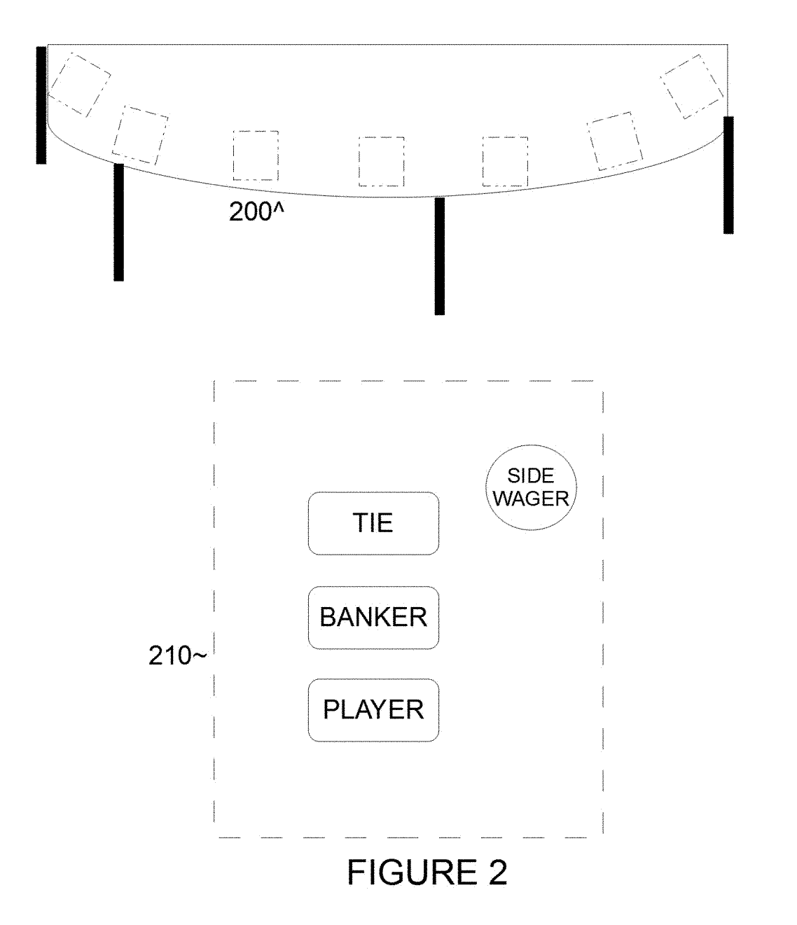

FIG. 2 is a drawing of a gaming table and layout according to an embodiment.

A physical gaming table 200 has five seats (although of course it can accommodate any other number). This table has seven individual betting areas.

An individual betting layout 210 is shown for each player for a baccarat game. Each such layout is in front of each of the players. A banker, player, and tie betting circles are used to place the main wagers (all wagers can be placed in the form of chips). Also present is an optional side wager betting circle.

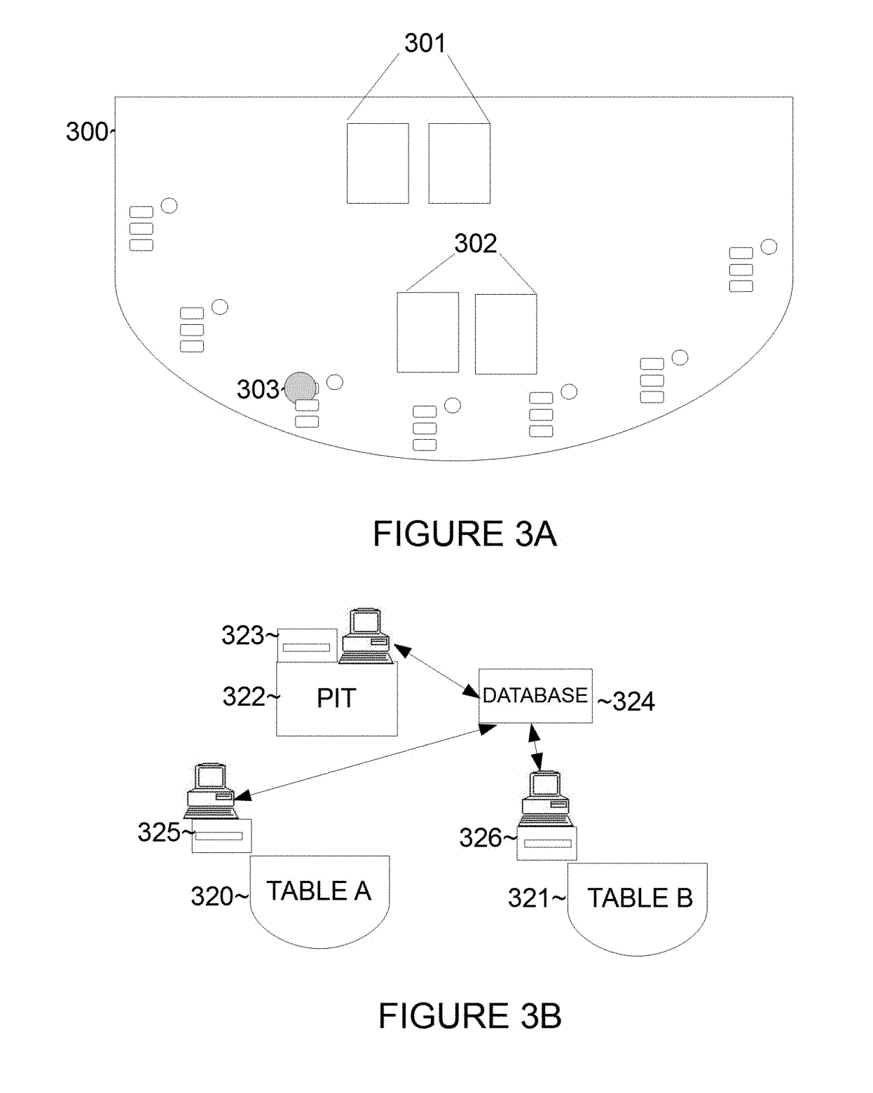

FIG. 3A is a drawing illustrating a gaming table, according to an embodiment.

A physical gaming table 300 (typically made of wood with felt on top with the layout imprinted on it) is used to play the game in a physical real world casino. One example of a table that can be used in a physical casino is illustrated in U.S. Design Pat. No. D263,975 which is incorporated by reference herein in its entirety. The layout on top of the felt has imprinted on it seven betting areas as illustrated in FIG. 3A, each betting circle is where the respective player can place their chips (wager). The felt can be green and the imprinted betting circles can be white, although of course any color scheme can be used. Such a table can accommodate any number of players (such as seven as illustrated) or any other number (e.g. 2-10). All players play simultaneously against the dealer as known in the art. A player's hand 302 and a dealer's (or banker's) hand 301 are shown. A player's wager 303 is shown in the form of a chip or chips and is placed inside the player's betting circle.

Also not pictured in FIG. 3A is an electronic mechanical shuffler such as that described in U.S. Pat. No. 8,025,294 which is incorporated by reference here in its entirety which can optionally be used by the dealer to shuffle the deck or decks of cards. Also not pictured in FIG. 3A is an optional shoe which the cards can be placed into and dealt out of by the dealer, such as the shoe described in U.S. Pat. No. 4,457,512 which is incorporated by reference herein in its entirety.

FIG. 3B is a block diagram illustrating an electronic player tracking system associated with each gaming table, according to an embodiment.

When players play casino table games the casino can typically track the player so that the casino knows how much gaming action a player is giving the casino and hence how much to reward each player with complimentaries (free or discounted rooms, food, etc.) Such a system is described in U.S. Pat. No. 5,836,817, which is incorporated by reference herein in its entirety for all purposes. Each player can have their own players card which is a plastic card that has their name imprinted on it and computer readable indicia (e.g., a magnetic stripe) which stores an identification number of the player's card (and hence the identification number of the player who owns the card). The player's card can be swiped through an electronic card readers 323, 325, 326 which can be electronic read and the data therein transmitted to the associated computer.

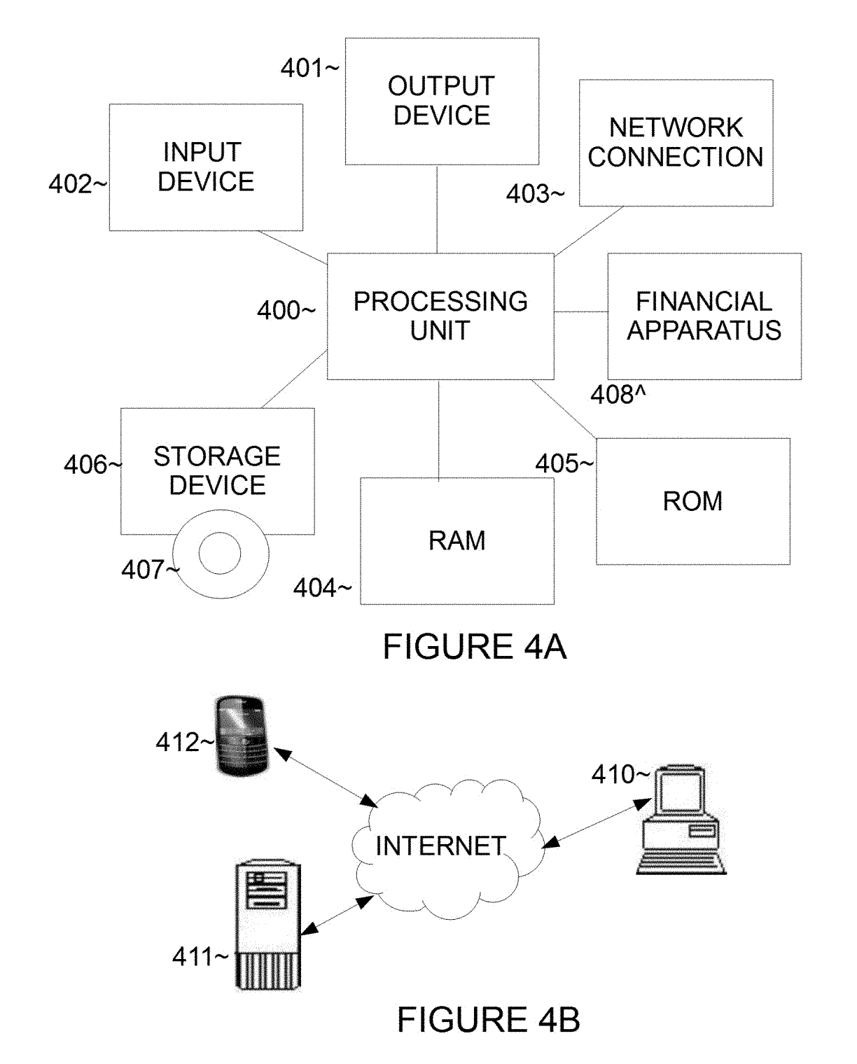

A gaming table A 320 (which can be used to play any method described herein) and a gaming table B 321 (which can be used to play any method described herein) can be associated with a pit 322 (which has its own computer) which has a card reader 323 to read the electronically encoded information on a player's card (the card reader can also be located at the tables themselves) and transmit the information to an associated computer which can communicate information contained on the player's card (e.g., an identification number of the player associated with the card) to the electronic database 324 along with play data relating to the player who owns the player's card. Table A 320 has its own card reader 325 and associated computer (the one next to card reader 325 which receives information from the card reader 325) and table B 321 also has its own card reader 326 and associated computer (the one next to card reader 326 which receives information from the card reader 526). The computers at table A 320 and table B 321 are connected to the electronic database 324. Casino employees can enter data regarding each player's play (for those players that present a players card) into a computer at the table or at the pit which transmits the play data (e.g., average bet/wager amount, time of play, etc.) to the electronic casino database 324 that stores playing history information for players at the casino. The computers illustrated in FIG. 3B can all have the structure as illustrated in FIG. 4A.

FIG. 4A is a block diagram illustrating hardware that can be used to implement electronic versions of the wagering methods described herein, according to an embodiment. The hardware can be, for example, an electronic gaming machine (EGM) used in casinos. The hardware can also be a personal computer, playing the game using the Internet at an Internet casino for real money. The hardware can also be a digital casino table, for example the kind described in U.S. Pat. No. 7,775,887, which is incorporated by reference herein in its entirety. The hardware can also be any computing device, such as a cellular phone, tablet, etc., and the methods described herein can be installed as software (e.g., an app) on the device. The hardware can also be any other type of device, working individually or in conjunction with other devices. The hardware can also be a digital poker table, of the kind described in U.S. Pat. No. 7,758,411 which is incorporated by reference herein in its entirety.

A processing unit 400 (such as a microprocessor and any associated components) is connected to an output device 401 (such as an LCD monitor, touch screen, CRT, etc.) which is used to display to the player any aspect of the method, and an input device 402 (e.g., buttons, a touch screen, a keyboard, mouse, etc.) which can be used to input from the player any decision made by the player. All methods described herein can be performed by the processing unit 400 by loading and executing respective instructions. The processing unit 400 can also be connected to a network connection 403, which can connect the electronic gaming device to a computer communications network such as the Internet, a LAN, WAN, etc. The processing unit 400 is also connected to a RAM 404 and a ROM 405. The processing unit 400 is also connected to a storage device 406 which can be a DVD-drive, CD-ROM, flash memory, etc. Multiple such processing units can also work in collaboration with each other (in a same or different physical location). A non-transitory computer readable storage medium 407 can store a program which can control the electronic device to perform any of the methods described herein and can be read by the storage device 406. The processing unit 400 can also be connected to a financial apparatus 408 which can receive cash and convert the received cash into playable credits for use by the player when playing the electronic device. When the player decides to cash out any remaining credits, the financial apparatus 408 can issue coins or a cashless ticket (voucher) for the remaining credits which is redeemable by the player.

While one processing unit is shown, it can be appreciated that one or more such processor can work together (either in a same physical location or in different locations) to combine to implement any of the methods described herein. Programs and/or data required to implement any of the methods/features described herein can all be stored on any non-transitory computer readable storage medium (volatile or non-volatile, such as CD-ROM, RAM, ROM, EPROM, microprocessor cache, etc.)

FIG. 4B is a block diagram illustrating an exemplary network configuration to implement a player playing an online version of the methods described herein. All the methods described herein can be implemented on an online casino for real money (credits which are purchased for cash and are redeemable for cash) or for non-cash value credits. A player uses a personal computer 410 (e.g., cell phone, tablet, PC, etc.) can connect to a server 411 (which can have the structure illustrated in FIG. 4A) using a computer communications network such as the Internet. The server 411 hosts an online casino which determines the outcomes of the game and serves the outcomes to the computer 410 so the computer 410 displays the outcomes to the player. Other users can also play at the online casino hosted by the server 411 simultaneously, such as using a cell phone 412 with wireless internet connectivity. Any number of players (e.g., 1 to 100 or more than 100) can be connected to the internet and can play simultaneously on the sever 411 even though these players are all located in different physical locations. The general structure of online casinos is well known in the art.

It is noted that the methods described herein can be played with any number of standard decks of 52 cards (e.g., 1 deck to 10 decks). A standard deck is a collection of cards comprising an Ace, two, three, four, five, six, seven, eight, nine, ten, jack, queen, king, for each of four suits (comprising spades, diamonds, clubs, hearts) totaling 52 cards. Cards can be shuffled or a continuous shuffling machine (CSM) can be used. A standard deck of 52 cards can be used, as well as other kinds of decks, such as Spanish decks, decks with wild cards, etc. The operations described herein can be performed in any sensible order. Furthermore, numerous different variants of house rules can be applied.

Note that in the embodiments played using computers (a processor/processing unit), “virtual deck(s)” of cards are used instead of physical decks. A virtual deck is an electronic data structure used to represent a physical deck of cards which uses electronic representations for each respective card in the deck. A virtual card is displayed on an electronic output device using computer graphics and is displayed to mimic a real life image of that card.

Methods described herein can also be played on a physical table using physical cards and physical chips used to place wagers. Such physical chips can be directly redeemable for cash. When a player wins (dealer loses) the player's wager, the dealer will pay that player a respective payout amount. When a player loses (dealer wins) the player's wager, the dealer will take (collect) that wager from the player and typically place those chips in the dealer's chip rack. All rules, embodiments, features, etc. of a game being played are typically communicated to the player (e.g., verbally or on a written rule card) before the game begins.

Initial cash deposits can be made into the electronic gaming machine which converts cash into electronic credits. Wagers can be placed in the form of electronic credits, which can be cashed out for real coins or a ticket (e.g., ticket-in-ticket-out) which can be redeemed at a casino cashier or kiosk for real cash and/or coins.

Any description of a component or embodiment herein also includes hardware, software, and configurations which already exist in the prior art and may be necessary to the operation of such component(s) or embodiment(s).

Further, the operations described herein can be performed in any sensible order. Any operations not required for proper operation can be optional. Further, all methods described herein can also be stored on a computer readable storage to control a computer. All variations and features described herein can be combined with any other features described herein without limitation. All features in all documents incorporated by reference herein can be combined with any feature(s) described herein, and also with all other features in all other documents incorporated by reference, without limitation.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A method for implementing a wagering game, the method comprising:
executing, on a processing unit, computer readable instructions that perform:
receiving a wager from a player;
receiving a side wager from the player;
dealing a player's hand a banker's hand;
completing a baccarat game according to predetermined rules;
providing side wager resolution rules comprising: a) if all cards in the player's hand are of a same color and all cards in the banker's hands are of an opposite color than the player's cards then the side wager wins a payout, b) otherwise if the previous condition is not satisfied then the side wager loses;
resolving the side wager according to the side wager resolution rules.

2. The method as recited in claim 1, wherein the side wager resolution rules further comprise that the greater a number of cards when combining the dealer's hand and the player's hand, the greater a payout on the side wager when the side wager wins.

3. An apparatus to implement a wagering game, the apparatus comprising:
an electronic input unit;
an electronic output unit;
a circuit connected to the input unit and the output unit, the circuit comprising a processor, the processor connected to a non-transitory storage device which stores computer readable instructions which cause the processor to:
receive a wager from a player;
receive a side wager from the player;
deal a player's hand a banker's hand;
complete a baccarat game according to predetermined rules;
provide side wager resolution rules comprising: a) if all cards in the player's hand are of a same color and all cards in the banker's hands are of an opposite color than the player's cards then the side wager wins a payout, b) otherwise if the previous condition is not satisfied then the side wager loses;
resolving the side wager according to the side wager resolution rules.

4. The apparatus as recited in claim 4, wherein the side wager resolution rules further comprise that the greater a number of cards when combining the dealer's hand and the player's hand, the greater a payout on the side wager when the side wager wins.
